(19) United States
(12) Patent Application Publication
(10) Pub. No.: US 2015/0084963 A1
(43) Pub. Date: Mar. 26, 2015

(54) METHOD OF DISPLAYING A PARAMETER

(71) Applicant: GE Aviation Systems Limited, Cheltenham (GB)

(72) Inventors: Donna Louise Green, Southampton (GB); Brian David Larder, Southampton (GB); Andrew James Smith, Southampton (GB); Peter Robin Knight, Southampton (GB)

(73) Assignee: GE Aviation Systems Limited, Cheltenham (GB)

(21) Appl. No.: 14/265,625

(22) Filed: Apr. 30, 2014

(30) Foreign Application Priority Data
Sep. 26, 2013 (GB) 13171111

(51) Int. Cl. G01D 7/02; G06T 11/20

(52) U.S. Cl. CPC G01D 7/02; G06T 11/206
USPC 345/440

(57) ABSTRACT

A method of displaying a parameter that can be modeled by an algorithm having multiple variables on a display to provide an understanding of an impact of the variables on the parameter, the method includes displaying on a first portion of the display a plot of the parameter for a first period and simultaneously with the display of the plot of the parameter, displaying on a second portion of the display, different from the first portion, a plot related to the parameter.

### CROSS-REFERENCE TO RELATED APPLICATIONS

This application claims priority under 35 U.S.C. §119 to British Patent Application No. 13171111, filed Sep. 26, 2013, the disclosure of which is incorporated herein by reference.

### BACKGROUND OF THE INVENTION

Contemporary systems, including aircraft, wind turbines, power plants, cars, trains, ship engines, etc. may have their health monitored. When monitoring the health of complex systems, large quantities of data are generated and may hinder the understanding of the health of the system.

### BRIEF DESCRIPTION OF THE INVENTION

In one aspect, an embodiment of the invention relates to a method of displaying on a display a parameter that can be modeled by an algorithm having multiple variables to provide an understanding of an impact of the variables on the parameter, the method includes displaying on a first portion of the display a plot of the parameter for a first time period and simultaneously with the display of the plot of the parameter, displaying on a second portion of the display, different from the first portion, a plot of at least raw data, related to the parameter, for some of the variables for at least a portion of the first time period and wherein at least some of the displayed plots of the raw data are displayed in separate portions of the second portion.

In another aspect, an embodiment of the invention relates to a method of displaying on a display a parameter that can be modeled by an algorithm having multiple variables to provide an understanding of an impact of the variables on the parameter, the method includes displaying on a first portion of the display a plot of the parameter for a first period and simultaneously with the display of the plot of the parameter, displaying on a second portion of the display, different from the first portion, plots related to the parameter, for some of the variables for at least a portion of the first period.

### BRIEF DESCRIPTION OF THE DRAWINGS

In the drawings:

FIG. 1 is a schematic illustration of an exemplary system.

FIG. 2 is a perspective view of the aircraft and a ground station in which embodiments of the invention may be implemented.

FIG. 3 is a flowchart showing a method of displaying a parameter according to an embodiment of the invention.

FIG. 4 is an exemplary layout of a display according to the method of FIG. 3.

FIG. 5 is an exemplary chart schematic that may form a first portion of the display.

FIG. 6 is an exemplary chart schematic illustrating multiple portions of the display including the first portion illustrated in FIG. 5.

FIG. 7 is an exemplary chart illustrating the chart of FIG. 6 with a plot partially expanded.

FIG. 8 is another exemplary chart schematic that may form a first portion of the display.

FIG. 9 is another exemplary chart schematic illustrating multiple portions of the display including the first portion illustrated in FIG. 8.

FIG. 10 is another exemplary chart schematic that may form a first portion of the display.

### DESCRIPTION OF EMBODIMENTS OF THE INVENTION

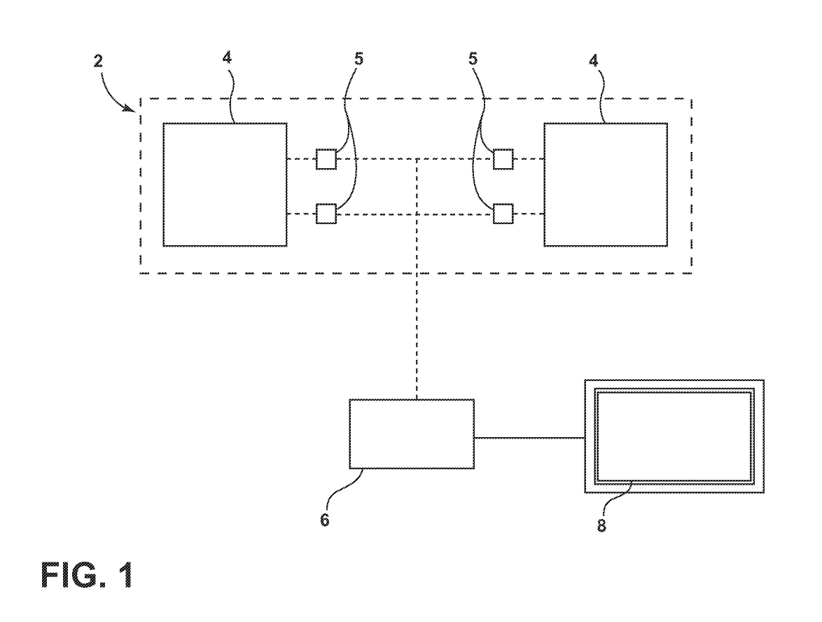

FIG. 1 schematically illustrates a system 2 having several components 4, which may have sensors 5 providing signals regarding aspects of the operation of each components 4. It will be understood that the system 2 may be any suitable system for which information may be collected and monitored for any given reason including for monitoring the health of the system. By way of non-limiting example, the system may include helicopter drivetrain and gearbox monitoring, aircraft engine health monitoring, wind turbine health monitoring, power plants, cars, trains, ship engines, etc.

The sensor signal may include raw or refined data, which may be provided to a controller 6. Depending on the system, raw data may be acquired from a number of sensors (e.g. temperatures, pressures, fuel flow and spool speed for a jet engine, power, winds speed and direction, and blade speed for a wind turbine, vibration from accelerometers and tachometers on helicopter drivetrains, etc.).

The controller 6 may be used to process such data. For example, the data may be processed in some way to derive features that make the component health stand out including by way of non-limiting examples generation of condition indicators of helicopter gear and bearing vibration data, or correcting to standard atmosphere condition, or calculating the difference between two related assets. Deviations from expected behavior may then be calculated. Thresholds or more advanced reasoning techniques, such as Bayesian networks, may then be used to alert users to abnormal or unhealthy conditions. For example, the controller 6 may provide an indication on a display 8. More specifically, the controller 6 may display on a first portion of the display 8 a plot of the parameter for a first time period and simultaneously with the display of the plot of the parameter the controller 6 may display on a second portion of the display, different from the first portion, a plot of at least raw data, related to the parameter, for some of the variables for at least a portion of the first time period. A user may then review the results to understand why the data has been flagged for attention.

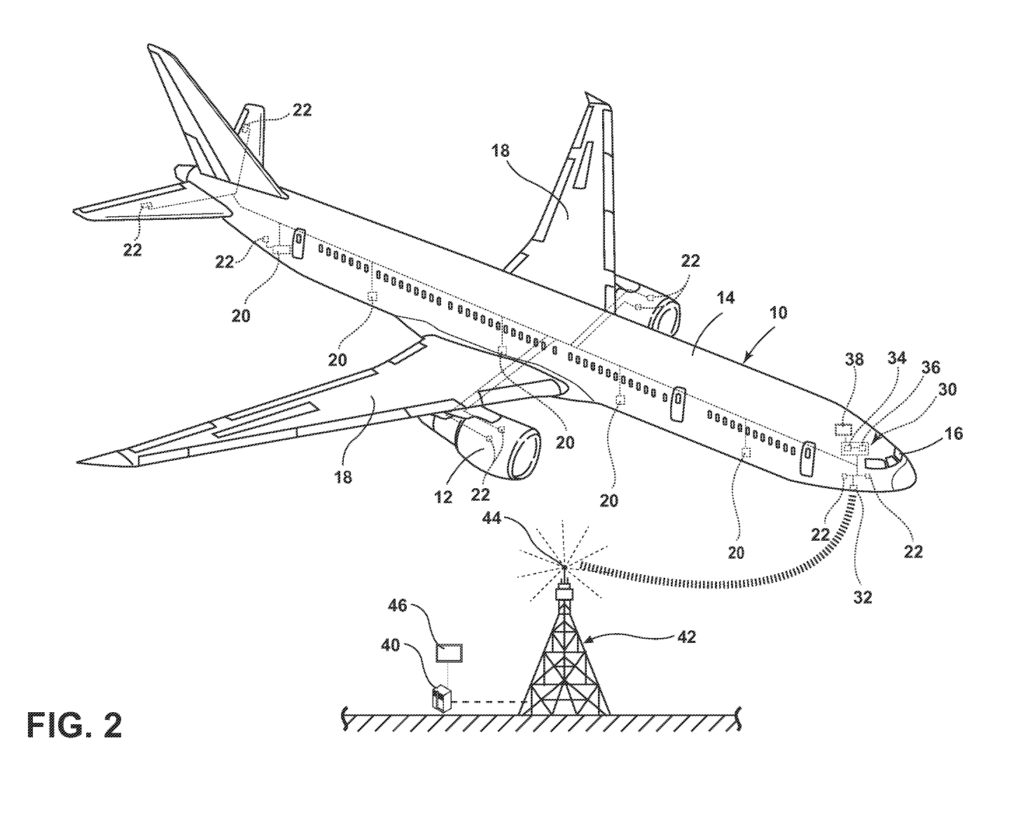

By way of non-limiting example, a system in the form of an aircraft 10 has been illustrated in FIG. 2. One or more propulsion engines 12 coupled to a fuselage 14, a cockpit 16 positioned in the fuselage 14, and wing assemblies 18 extending outward from the fuselage 14 may be included in the aircraft 10. A plurality of additional aircraft systems 20 that enable proper operation of the aircraft 10 may also be included in the aircraft 10. Further, one or more sensors 22 may be included and each may output data relevant to a characteristic of a component of the aircraft 10. For example, sensors 22 related to the engine 12 may provide data regarding temperatures, pressures, fuel flow and spool speed for the engine.

A controller 30 and a communication system having a wireless communication link 32 may also be included in the aircraft 10. The controller 30 may be operably coupled to the engines, plurality of aircraft systems 20, the sensors 22, etc. The controller 30 may also be connected with other controllers of the aircraft 10. The controller 30 may include memory 34, the memory 34 may include random access memory (RAM), read-only memory (ROM), flash memory, or one or more different types of portable electronic memory, such as discs, DVDs, CD-ROMs, etc., or any suitable combination of these types of memory. The controller 30 may include one or more processors 36, which may be running any suitable programs. The controller 30 may be a portion of a Flight Management System (FMS) or may be operably coupled to the FMS.

A computer searchable database of information may be stored in the memory 34 and accessible by the processor 36. The processor 36 may run a set of executable instructions to display the database or access the database. Alternatively, the controller 30 may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases. The database may store data that may include historical data related to the expected behaviors of the various components of the aircraft 10 and related to a fleet of aircraft. The database may also include reference values related to the components.

Alternatively, it is contemplated that the database may be separate from the controller 30 but may be in communication with the controller 30 such that it may be accessed by the controller 30. For example, it is contemplated that the database may be contained on a portable memory device and in such a case, the aircraft 10 may include a port for receiving the portable memory device and such a port would be in electronic communication with controller 30 such that controller 30 may be able to read the contents of the portable memory device. It is also contemplated that the database may be updated through the wireless communication link 32 and that in this manner, real time information such as information regarding historical fleet-wide data may be included in the database and may be accessed by the controller 30. Further, it is contemplated that such a database may be located off the aircraft 10 at a location such as airline operation center, flight operations department control, or another location. The controller 30 may be operably coupled to a wireless network over which the database information may be provided to the controller 30.

A flight display 38 may be operably coupled with the controller 30 and the controller 30 may drive the flight display 38 to generate a display thereon. In this manner, the flight display 38 may visually express information pertaining to the aircraft 10. The flight display 38 may be a primary flight display, a multipurpose control display unit, or other suitable flight display commonly included within the cockpit 16.

While a commercial aircraft has been illustrated, it is contemplated that portions of the embodiments of the invention may be implemented anywhere including in a computer 40 at a ground system 42. Furthermore, database(s) as described above may also be located in a destination server or a computer 40, which may be located at and include the designated ground system 42. Alternatively, the database may be located at an alternative ground location. The ground system 42 may communicate with other devices including the controller 30 and databases located remote from the computer 40 via a wireless communication link 44. The ground system 42 may be any type of communicating ground system 42 such as an airline control or flight operations department. A display 46 may be operably coupled with the computer 40 and the computer 40 may drive the display 46 to generate a display thereon.

One of the controller 30 and the computer 40 may include all or a portion of a computer program having an executable instruction set for displaying a parameter that can be modeled by an algorithm having multiple variables. Regardless of whether the controller 30 or the computer 40 runs the program for displaying the parameter, the program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implement particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

It will be understood that the aircraft 10 and computer 40 merely represent two exemplary embodiments that may be configured to implement embodiments or portions of embodiments of the invention. During operation, either the controller 30 and/or the computer 40 may display a parameter that can be modeled by an algorithm having multiple variables. By way of non-limiting example, the controller 30 and/or the computer 40 may utilize inputs from the components of the aircraft 10 including its sensors 22, the database(s) and/or information from airline control or flight operations department to display a parameter that can be modeled by an algorithm having multiple variables. The wireless communication link 32 and the wireless communication link 44 may both be utilized to transmit data such that either the flight display 38 or the display 46 may be utilized by either the controller 30 and/or the computer 40 to display on a first portion of a plot of the parameter for a first period and simultaneously display on a second portion of the display, different from the first portion, a plot related to the parameter, for some of the variables for at least a portion of the first period.

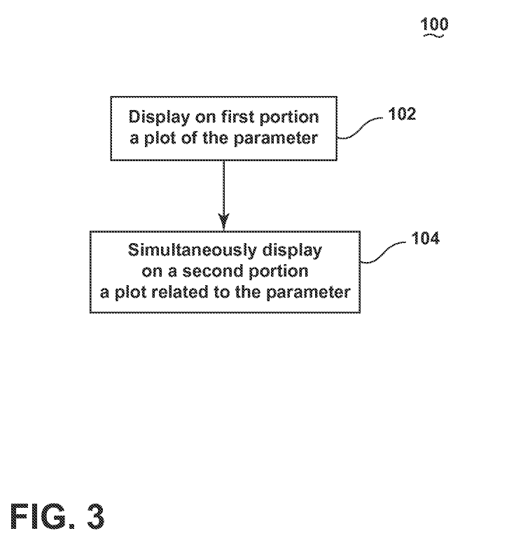

In accordance with an embodiment of the invention, FIG. 3 illustrates a method 100, which may be used for displaying a parameter that can be modeled by an algorithm having multiple variables on a display to provide an understanding of an impact of the variables on the parameter. The method 100 begins at 102 by displaying on a first portion of the display a plot of the parameter. The plot of the parameter may be displayed for a first time period. Simultaneously with the display of the plot of the parameter at 102 the method 100 at 104, displays on a second portion of the display, different from the first portion, a plot related to the parameter, for some of the variables for at least a portion of the first time period.

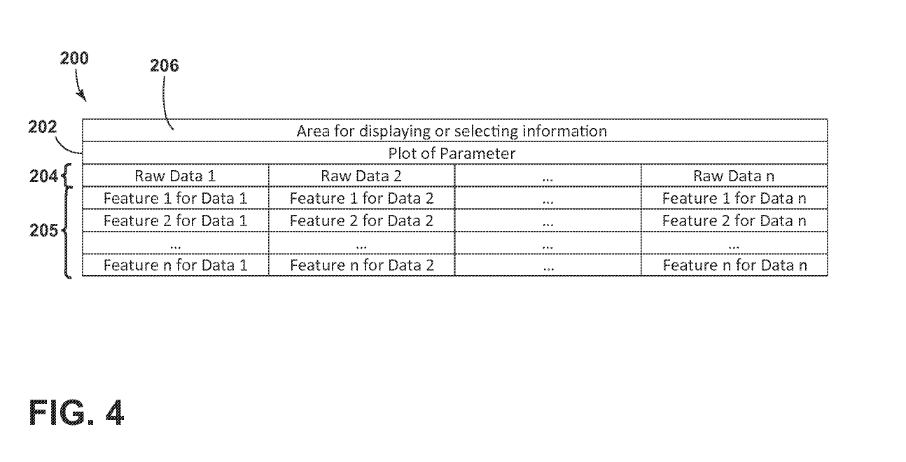

FIG. 4 illustrates a schematic example of a layout of the display of such information according to the method 100. The display 200 includes a first portion 202, which may be used to display the plot of the parameter for the first time period. In FIG. 4, it is indicated that the second portion 204 may be used to display plots of at least raw data, related to the parameter, for some of the variables for at least a portion of the first time period, although alternative plots may be displayed. As illustrated, the second portion 204 may be used to display multiple plots of at least raw data and at least some of the displayed plots of the raw data are displayed in separate portions of the second portion 204.

It will be understood that the method of displaying the parameter is flexible and the method illustrated is merely for illustrative purposes. For example, the sequence of steps depicted is for illustrative purposes only, and is not meant to limit the method 100 in any way as it is understood that the steps may proceed in a different logical order or additional or intervening steps may be included without detracting from embodiments of the invention. By way of non-limiting example, the method 100 may also include simultaneously with the display of the plot of the parameter and the raw data, displaying on additional portions 205 additional information related to features of the raw data. It will be understood that any suitable information related to any suitable features may be displayed in the additional portions 205. Examples of which will be disclosed with further detail herein.

By way of further example, the plot displayed on the first portion may have an alternative X-axis so that its period is measured by something other than time. By way of non-limiting example, the X-axis may be measured as a linear distance from a geological event or any other suitable variable. It will be understood that regardless of how the X-axis is measured the displaying of the plot of the parameter may be considered to be for a first period. Furthermore, the display of the plots related to the parameter in the second portion need not be raw data. Instead, the second portion may include alternative features related to the parameter including smoothed data, filtered data, corrected data, influence factors, residuals, etc.

By way of additional example, the method may include displaying a user input field or an area 206 for displaying or selecting various options with respect to the display 200. While the top of the display 200 has been illustrated as including this area, it will be understood that such an area may be anywhere, auto-hidden, or the user may have control to place it where desired. The area 206 may display enough information to know what data is being plotted. Further, the area 206 may include selectable items to allow the user to select what to display including that the area may have a parameter selection and a time period selection. The parameter selection may include an individual engine serial number, a wind turbine, a helicopter gearbox, etc. The selection may be made in any suitable manner including that it may be typed in, selected from a list, etc. By way of additional example, a model or technique of interest may be selected. Such a technique may be that which will be used to identify the anomaly or a predefined process or set of parameters that the user finds helpful for diagnosing faults. In such an instance, such a selection may include processing techniques such as normalizing to standard atmosphere conditions, removing outliers, modeling techniques such as diagnostic or fault prediction, neural networks, and physics based models of the asset. Such models may have various relevant data associated therewith. Further, additional options such as whether and which related component or asset to display, which series to display, displaying information not selected, etc. may be included in the area 206.

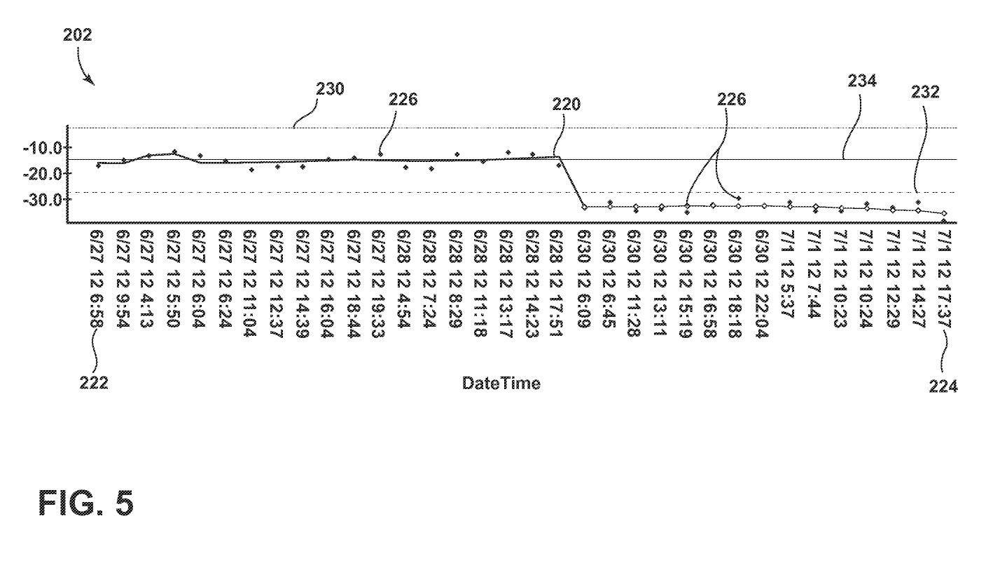

FIG. 5 illustrates one example of a first portion 202 displaying a plot of the parameter 220 for a first time period ranging from a first time at 222 to a second time at 224. The time may be measured in any suitable manner including calendar hours, days, weeks, months, years, asset run time, by cycles (e.g. starts and stops or takeoffs and landings), or by records. It will be understood that the plot of the parameter 220 may be illustrated over any time period and that the time period illustrated may be selectable by a user or predetermined. Selection options may include all time, an amount of time, data since an event, or a specified range.

Further, data points 226 from which the plot of the parameter 220 has been derived from are illustrated although this need not be the case. In the illustrated example, the plot of the parameter 220 is a smoothed representation of the data points 226, although this need not be the case. The smoothed line may be formed in any suitable manner including that the line may represent a loess smoother, an exponential smoother, or a moving average. The plot of the parameter 220 may be plotted in the same color as the data points 226 being smoothed. It is contemplated that the plot of the parameter 220 may or may not include the actual data points 226.

Further, fleet-wide information, standard deviation bounds, interquartile lines, or thresholds may be included on the first portion 202 to draw a user's attention to significant features or period. By way of non-limiting examples, this may be done to aid a user in judging how anomalous the data is or to illustrate overall cost savings and drivers. Such additional information may be helpful in allowing the user to visualize how the parameter data compares to other assets in the fleet. In the illustrated example, other values including a fleet upper limit 230, a fleet lower limit 232, and fleet mean value 234 have been illustrated to aid in such assessment.

Further, the displayed plot of the parameter 220 may identify anomalous data for the parameter. For example, in the illustrated example, once the plot of the parameter 220 falls below the fleet lower limit 232, the data points 226 on the plot of the parameter 220 may be shown differently, either with a differing plot line or differing data point style or color, indicating an alert condition. For example, if different colors are used, the alerting points may be colored red and yellow may be used to indicate less severe alerts or alert duration (e.g. 3 out of 4 points above a threshold).

It will be understood that the display of information in the first portion 202 may be made in any suitable manner including that the information may be ordered. To aid in a user identifying information in the first portion 202, the information may be ordered on the display. More specifically, the information may be plotted in an order so that less important information (such as event markers, fleet stats, etc.) may be plotted behind the more important data (such as the selected assets data and alerting points).

In this manner, the plot of the parameter 220 may illustrate an overall health of the system in the first portion 202. Because numerous data, including a variety of charts, may be illustrated on the display, the chart of the overall health of the system is included to provide a single health measure chart, which may help clarify what regions might be of interest to a user. By way of non-limiting example, the overall health may be measured by a fitness score, which may become more negative the more anomalous the data point. In this manner, the chart of the overall health of the system may provide a useful summary over many parameters of any abnormal data.

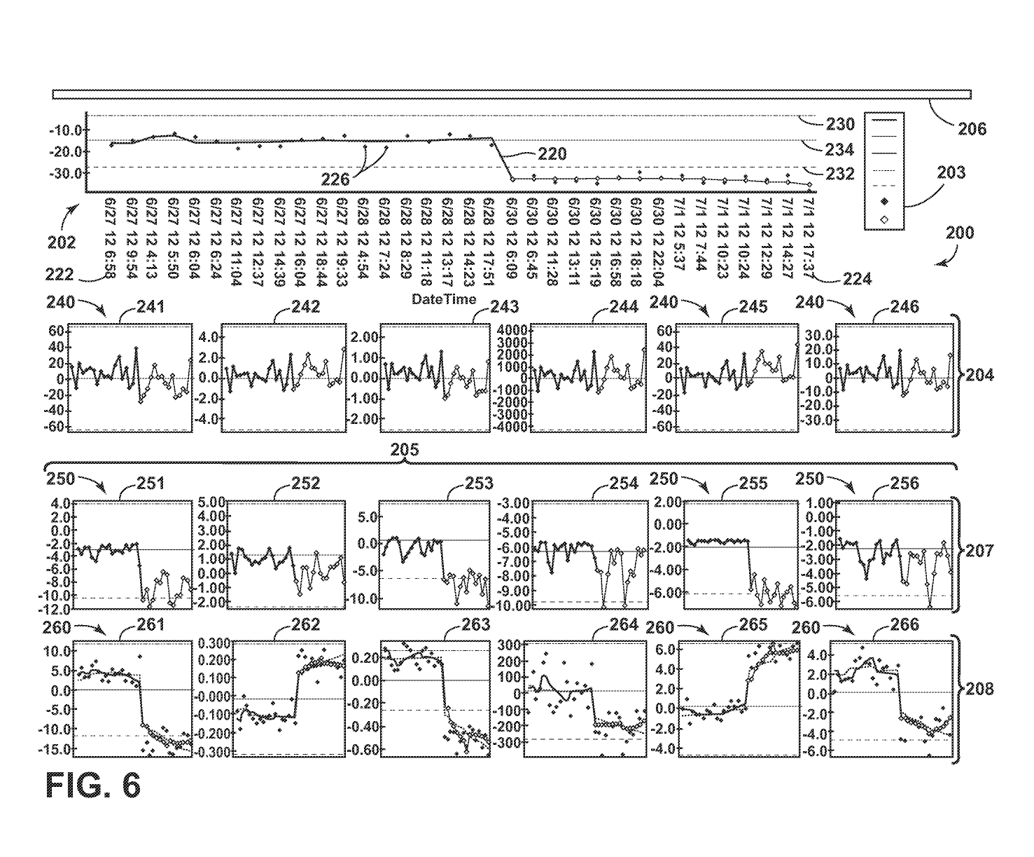

FIG. 6 illustrates one example of the display 200 illustrating both a first portion 202 displaying a plot of the parameter 220, as illustrated in FIG. 5, as well as a key 203 related to the plot of the parameter 220. Further, while not included in the exemplary illustration the display 200 may include any suitable labels and each chart may have a title indicating the parameter being plotted as well as units displayed. Further, the second portion 204, displaying plots of raw data 240, related to the parameter, for some of the variables have been illustrated. At least some of the displayed plots of the raw data 240 are displayed in separate portions of the second portion 204.

The raw data may be any suitable data received from the system. By way of non-limiting example, the asset may include an engine for an aircraft and the plots of raw data 240 may include a plot related to the exhaust gas temperature at 241, which may be expressed in degrees centigrade, a plot related to the fan spool speed at 242, which may be expressed as a percentage, a plot related to the core spool speed at 243, which may be expressed as a percentage, a plot of a fuel flow rate at 244, which may be expressed in pounds per hour, a plot of the compressor discharge static pressure at 245, which may be expressed in pounds per square inch absolute, and a plot of a compressor outlet temperature at 246, which may be expressed in degrees centigrade. It will be understood that any suitable plots of raw data may be included in the second portion 204 and that such plots will change depending on the asset or component being monitored. Further, each of the plots may include a fleet upper limit, a fleet lower limit, and fleet mean value. At least some of the displayed plots of the raw data may identify anomalous data for the variables. Anomalous data may be determined when a comparison indicates that the data satisfies a predetermined threshold. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted. In the illustrated examples, when the plots are outside of the fleet upper limit or fleet lower limit it may be determined that the data is anomalous.

By way of further non-limiting example, the method may also include simultaneously with the display of the plot of the parameter 220 and the raw data in the second portion 204, displaying on a third portion 207 of the display 200, different from the first portion 202 and the second portion 204, a plot of another feature related to the parameter. For example, an influence factor for at least some of the displayed raw data may be illustrated in the third portion 207. The influence factor may measure the degree to which that underlying parameter is driving the behavior in the plot of the parameter 220. By way of further example, the method 100 may also include simultaneously with the display of the plot of the parameter, raw data, and influence factor, displaying on a fourth portion of the display 208, different from the first portion 202, second portion 204, and third portion 207, a plot of yet another feature related to the parameter. For example, a residual for at least some of the displayed raw data may be illustrated in the fourth portion 208. In the illustrated example, each plot of raw data has a corresponding plot for influence factor and residual although this need not be the case. Further, at least some of the displayed plots for the influence factor and residual may identify anomalous data.

In the illustrated example, the first portion 202 is arranged as a row along with the plots of raw data 240, plots of influence factors 250, and plots of residuals 260. The rows are arranged top to bottom in the following order: first portion 202, second portion 204, third portion 207, and fourth portion 208, although this need not be the case. In this manner, the remainder of the display 200 is used to plot relevant parameters for the selected model. Typically, the second potion 204 would include the raw data, or the input data to the model. Subsequent rows may include alternative information such as deltas/residuals (i.e. the difference between the models expected value and the actual measure value), or measures of how much the individual parameter has contributed to the overall component health index (e.g. influence factors). In the illustrated example, the second portion 204, third portion 207, and fourth portion 208 are arranged in rows, with the plot of raw data 240 and corresponding plot of influence factor and plot of residual are arranged within the rows to form a column. It is contemplated that to make the data easier to read that each column contains plots for the same parameter and each row is the same type of feature or illustrates the same function. Further, since the charts may be very small on the overall display 200 the X-axis labels may not be shown, since these are the same for all charts. It will be understood that all of the X-axes may have the same dimension and scale.

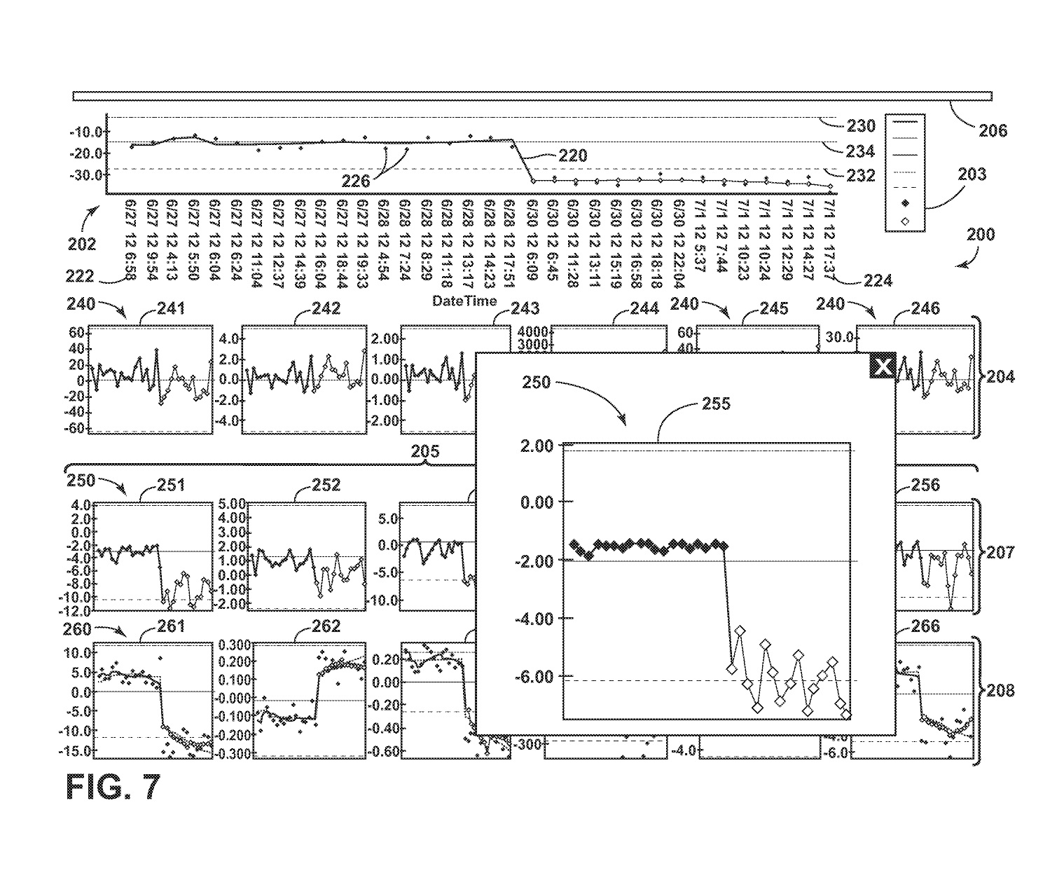

Further, all of the plots including the plots of raw data, influence factor, and residuals may be contained within a separate window, which can be expanded in response to a user input. Further, each chart may be capable of expanding including to the size of the full screen, zoomed and paned. For example, FIG. 7 illustrates the plot 255 expanded larger than its normally displayed size. While the plot 255 has been shown only partially expanded it will be understood that each of the charts may be expanded to any suitable size including to a full size of the display excluding the first portion and to the full size of the display. Furthermore, it is contemplated that data in one portion may be selected and associated data on all portions may be highlighted.

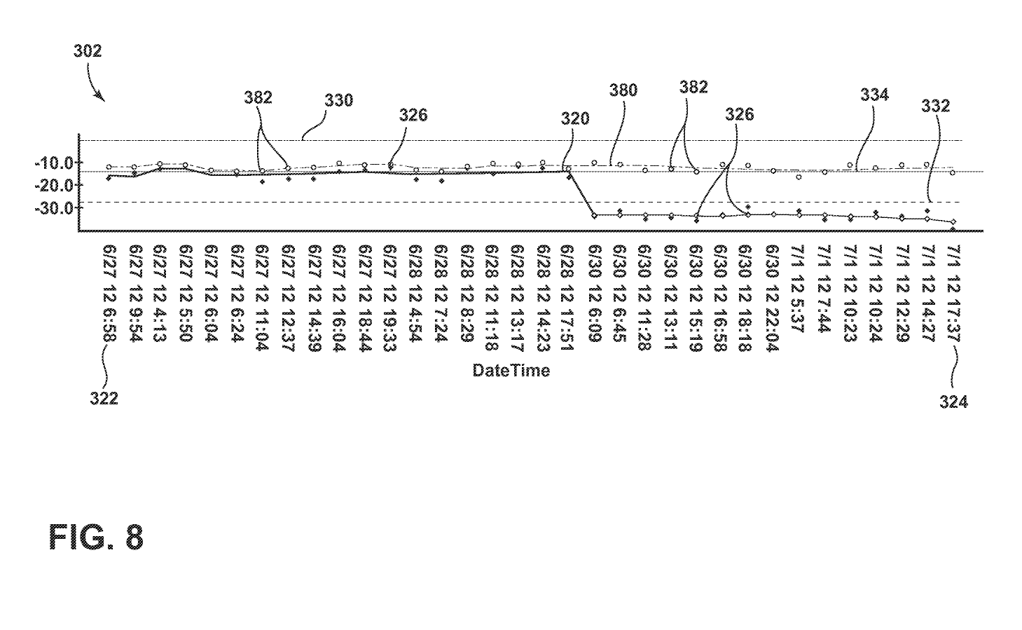

FIG. 8 is another exemplary chart schematic that may form a first portion of the display. This embodiment is similar to the display illustrated in FIG. 5; therefore, like parts will be identified with like numerals increased by 100, with it being understood that the description of the like parts of FIG. 5 applies to this embodiment, unless otherwise noted. One difference is that on the first portion 302 of the display a plot of a related parameter 380 for the first time period is also displayed. Further, data points 382 from which the plot of the parameter 380 has been derived from are illustrated, although this need not be the case.

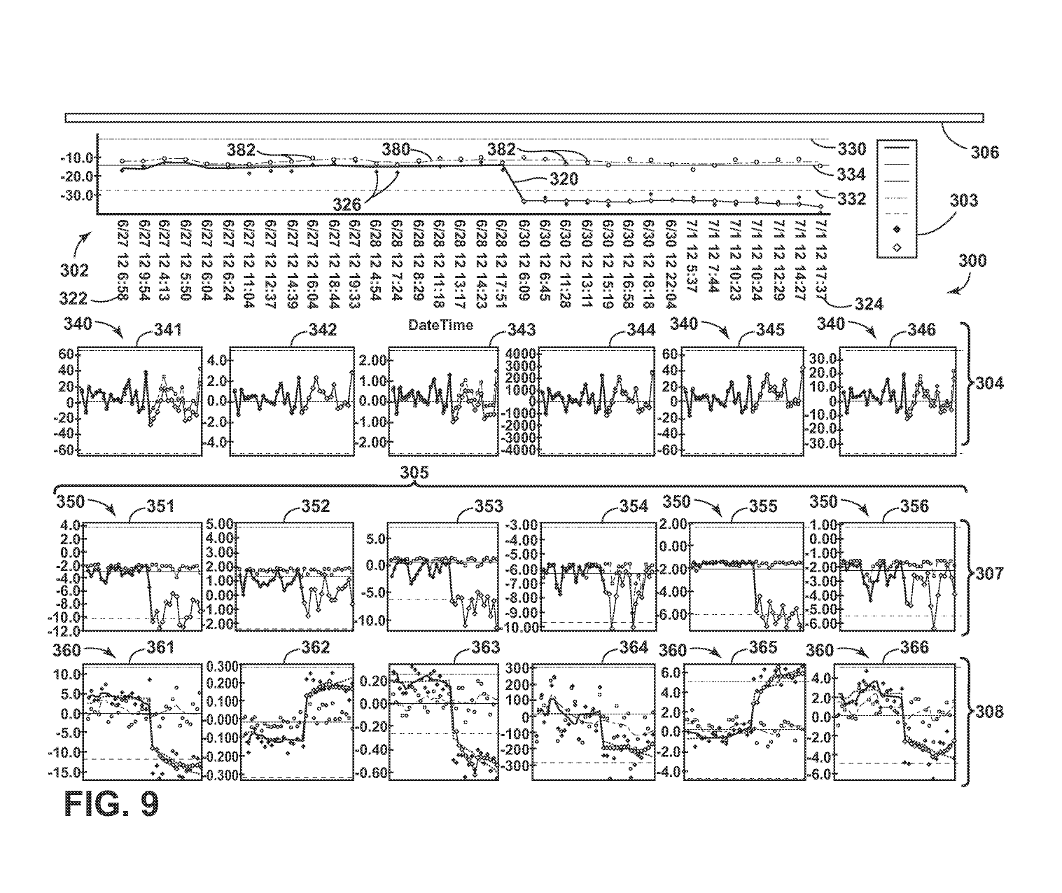

Furthermore, as illustrated in FIG. 9, on the second portion 304 of the display a plot of at least raw data, related to the related parameter is also displayed. Further still, plots related to the related parameter are included in the plots of influence factors 350, and plots of residuals 360. The plots related to the related parameter may provide a user with additional useful information and may more easily allow a user to see data trends by comparing with related asset data that was operating at the same time under the same conditions. By way of non-limiting example, the parameter may correlate with information related to a first engine 12 on the aircraft 10 and the related parameter may correlate with information related to a second engine 12 on the aircraft 10. For example, on a twin-engine aircraft 10, data for the other engine 12 will usually mirror that of the monitored engine 12 and may help account for variability. It will be understood that the related parameter may be any suitable parameter related to the first parameter. By way of further non-limiting examples, the related parameter may include: a nearby wind turbine exposed to the same wind conditions, two bearings that are next to each other on a helicopter gearbox. Furthermore, it will be understood that more than one related asset could be plotted at once.

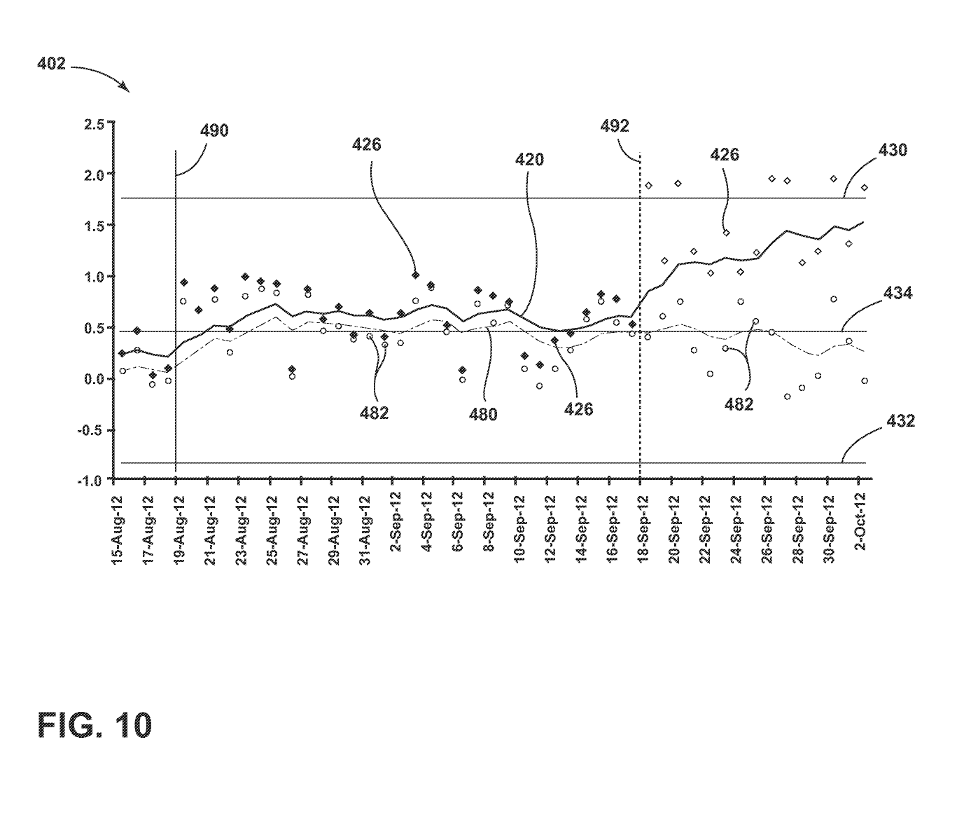

FIG. 10 is another exemplary chart schematic that may form a first portion 402 of the display. This embodiment is similar to the display illustrated in FIG. 5; therefore, like parts will be identified with like numerals increased by 200, with it being understood that the description of the like parts of FIG. 5 applies to this embodiment, unless otherwise noted. One difference is that the first portion 402 includes event markers that act to highlight other useful information such as dates of maintenance events 490 and detected shifts 492.

Technical effects of the above described embodiments include that large amounts of data gathered from a complex system may be easily assessed by a user as the relevant data may be quickly and efficiently conveyed to a user. The above described embodiments allow for anomalous data to be illustrated. The above described embodiments allow for a variety of data related to a parameter having multiple variables to be displayed in an easily understood format that combines the display of an overall summary parameter with more detailed individual parameter information. The displaying of such data may be broadly applicable to any health monitoring system.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of displaying, on a display, a parameter that can be modeled by an algorithm having multiple variables to provide an understanding of an impact of the variables on the parameter, the method comprising:
displaying on a first portion of the display a plot of the parameter for a first time period; and
simultaneously with the display of the plot of the parameter, displaying on a second portion of the display, different from the first portion, plots of at least raw data, related to the parameter, for some of the variables for at least a portion of the first time period; and
wherein at least some of the displayed plots of the raw data are displayed in separate portions of the second portion.

2. The method of claim 1 wherein at least some of the displayed plots of the raw data identify anomalous data for the variables.

3. The method of claim 2 wherein the displayed plot of the parameter identifies anomalous data for the parameter.

4. The method of claim 1, further comprising simultaneously with the display of the plot of the parameter and the raw data, displaying on a third portion of the display, different from the first and second portions, a plot of an influence factor for at least some of the displayed raw data.

5. The method of claim 4, further comprising simultaneously with the display of the plot of the parameter, raw data, and influence factor, displaying on a fourth portion of the display, different from the first, second, and third portions, a plot of a residual for at least some of the displayed raw data.

6. The method of claim 5 wherein each plot of raw data has a corresponding plot for influence factor and residual.

7. The method of claim 6 wherein the second, third, and fourth portions are arranged in rows, with the plot of raw data and corresponding plot of influence factor and plot of residual are arranged within the rows to form a column.

8. The method of claim 7 wherein the X-axes of all of the plots in the second, third, and fourth portions are the same dimension and scale, each row illustrates a single illustrated function and each column is limited to a single variable.

9. The method of claim 7 wherein each of the plots of raw data, influence factor, and residuals are contained within a separate window, which can be expanded in response to a user input.

10. The method of claim 9 where the rows are arranged top to bottom in the following order: first portion, second portion, third portion, and fourth portion.

11. The method of claim 10, further comprising a user input field comprising at least one of a parameter selection and a time period selection.

12. The method of claim 1, further comprising displaying on the first portion of the display a plot of a related parameter for the first time period.

13. The method of claim 12 wherein the parameter correlates with information related to a first engine on an aircraft and the related parameter correlates with information related to a second engine on the aircraft.

14. The method of claim 12 wherein simultaneously with the display of the plot of the related parameter, displaying on the second portion of the display a plot of at least raw data, related to the related parameter, for some of the variables for at least a portion of the first time period.

15. A method of displaying, on a display, a parameter that can be modeled by an algorithm having multiple variables to provide an understanding of an impact of the variables on the parameter, the method comprising:
displaying on a first portion of the display a plot of the parameter for a first period; and
simultaneously with the display of the plot of the parameter, displaying on a second portion of the display, different from the first portion, plots related to the parameter, for some of the variables for the first period wherein the X-axes of the plots are the same dimension and scale.
